(19) United States
(12) Patent Application Publication
(10) Pub. No.: US 2018/0095344 A1
(43) Pub. Date: Apr. 5, 2018

(54) CAMERA

(71) Applicant: TomTom International B.V., Amsterdam (NL)

(72) Inventors: Martin Riddiford, London (GB); Christopher James Taylor, London (GB); Frank De Jong, London (GB); Yu-Chyuan Tseng, New Taipei City (TW); Hadyn Macquire Lyall Van Der Berg, Surbiton (GB); Jonathan Heath, Barnet (GB); Eveline Anna Kleinjan, London (GB)

(21) Appl. No.: 15/567,097

(22) PCT Filed: Apr. 29, 2016
(86) PCT No.: PCT/EP2016/059701

§ 371 Date: Oct. 17, 2017

(30) Foreign Application Priority Data
Apr. 29, 2015 (GB) 1507320.8

(51) Int. Cl. G03B 17/08; H04N 5/77; G03B 11/06; G03B 11/04; H04N 5/907

(52) U.S. Cl. CPC G03B 17/08; H04N 5/772; G03B 2217/007; G03B 11/041; H04N 5/907; G03B 11/06

(57) ABSTRACT

A removable power pack for a camera is disclosed comprising a battery module and a data storage module housed in a common casing to form an integrated unit, wherein the casing exposes one or more electrical connectors for transmitting power and data between the power pack and a camera that receives the power pack. A waterproof camera is also disclosed comprising a camera body and a removable power pack installed in or on the body, the removable power pack including one or more electrical connectors for transmitting power to the camera once installed, and a sealing interface arranged between the camera and the power pack to prevent moisture from reaching the one or more electrical connectors.

### FIELD OF THE INVENTION

This invention relates to cameras, including still cameras and particularly video cameras. Furthermore the invention relates to power packs for cameras and to waterproof cameras. Illustrative embodiments of the invention relate to video cameras for use during outdoor activities and action sports (e.g. cycling, mountain biking, hiking, climbing, skiing and snowboarding, surfing, sky diving, sub-aqua), for example wearable video cameras that can be mounted to a helmet, bicycle, surf board, etc. to capture action footage.

### BACKGROUND OF THE INVENTION

Conventional still and video cameras are limited in their use during action sports as they are not usually designed to withstand outdoor weather conditions or wet environments. Those video cameras that are marketed as “action cams” are only splash-proof at best and generally require a separate housing to seal around the whole camera body for waterproof use. The waterproof housing is necessary because the camera body includes various openings, typically a battery compartment, memory card slot, auxiliary input/output (e.g. USB port), microphone, etc., which would inevitably allow for the ingress of water—especially if the camera were to be submerged or used underwater.

Another important consideration when taking still images or video footage of live action sports is the ability to capture exciting moments or sequences of activity. It is usually desirable to take many photos or record a large volume of video footage so as not to miss highlights. This is usually followed by a time-consuming editing process once the data files have been downloaded from the camera. A problem with a camera recording a large amount of data, especially large video files, is that the memory card or other data storage medium is rapidly filled and needs to be replaced during use. Furthermore the required power consumption, especially if a camera is used for long continuous periods, will deplete the battery so that it also needs replacing or recharging. Of course it is not generally possible for a user to recharge a battery during outdoor activities. The need to replace the memory card and/or battery can be inconvenient during sports activities (e.g. the user may be wearing protective gloves and the environmental conditions may be harsh) and the time taken can result in exciting moments of action being missed.

Some camera manufacturers have attempted to address these issues by offering a range of accessories including a waterproof housing and add-on battery packs. For example, WO 2010/005975 A1 discloses an “expansion module” that can be connected to a video camera to provide additional functionality, e.g. a battery pack with a display screen or WiFi capability.

However there remains a need for cameras, in particular video cameras, that are better suited to use during action sports and outdoor activities.

### SUMMARY OF THE INVENTION

According to a first aspect of the present invention there is provided a removable power pack for a camera comprising a battery module and a data storage module housed in a common casing to form an integrated unit, wherein the casing exposes one or more electrical connectors for transmitting power and data between the power pack and a camera that receives the power pack.

It will be appreciated that such a power pack represents a completely different approach to the battery units normally connected to a camera, as it combines a battery module with a data storage module, such as a slot for a memory card or other data storage medium. This means that a user can quickly and easily swap the integrated unit to replace both battery and memory in one step, which is much more efficient especially when out action filming. The electrical connector(s) can transmit both power and data, allowing the camera to write image or video data files directly to the removable power pack.

In at least some embodiments a removable data storage medium is installed in the data storage module of the power pack e.g. ready for use. Rather than fumbling around, potentially hindered by gloves and environmental conditions such as rain or snow, a user can disconnect one power pack and connect another to the camera without needing to handle a memory card. The risk of losing or damaging the data storage medium is reduced because it is safely installed in the power pack.

A further advantage of the integrated nature of such a removable power pack is that it may more easily be made waterproof, water resistant or splash resistant, e.g. using the common casing to protect both the battery module and data storage module. In some embodiments the power pack may be substantially sealed against the ingress of moisture, for example comprising a sealed casing. This means that the battery module and data storage module are both protected from a wet environment, e.g. if a power pack is removed or replaced by a user during outdoor activities. Accordingly the power pack may not need to be stored in a waterproof enclosure in the same way as conventional camera accessories that are used outdoors.

However, complete sealing of the power pack may interfere with the exposed electrical connector(s), e.g. on a surface of the power pack and make it more difficult to remove a data storage medium and/or battery from the modules (where such removable components are provided). It is also preferable for the power pack to be compatible with existing technologies and to include a conventional memory card slot rather than a sealed data storage module. Accordingly the power pack may not itself be completely sealed but can be provided with a removable cover that prevents the ingress of moisture. When the cover is installed the power pack can be completely waterproof, e.g. up to depths of 50 m. A sealing connection may be provided between the power pack and the cover. The cover can be removed when a user is swapping over power packs, or when changing a battery or data storage medium in the respective battery and data storage modules.

Furthermore, the Applicant has recognised that by combining both power and data in a single power pack it can be easier for the entire camera to be made waterproof. In a particularly preferred set of embodiments the power pack comprises a seal extending around a peripheral surface of the casing. When the power pack is received by a camera, preferably at least partially installed in or on a camera body, the seal ensures that water cannot penetrate beyond the seal to reach the electrical connector(s). The seal may also prevent moisture from reaching other components of the battery module and/or data storage module. In this novel approach the power pack provides its own seal rather than trying to seal the multiple openings present in a conventional camera, e.g. battery compartment and memory card slot. If the rest of the camera is waterproof then such a power pack means that an external waterproof casing may no longer be required. This is considered inventive in its own right.

According to a second aspect of the present invention there is provided a waterproof camera comprising a camera body and a removable power pack installed in or on the body, the removable power pack including one or more electrical connectors for transmitting power to the camera once installed, and a sealing interface arranged between the camera and the power pack to prevent moisture from reaching the one or more electrical connectors.

It will be appreciated that the whole camera can more easily be made waterproof by providing the sealing interface, so that a separate waterproof case is no longer required. In particular, the sealing interface means that the power pack can be removed and replaced directly from the waterproof camera. It is no longer necessary to open and close a separate waterproof case when swapping over the battery during use, making it quicker for a user with less risk of missing out on action footage. Preferably the camera has a water resistant rating of at least IPX7. This International Protection Marking, according to IEC standard 60529, rates the degree of protection provided against liquid intrusion by mechanical casings and electrical enclosures. A rating of IPX7 means that the camera can withstand immersion in water depths of up to 1 m for up to 30 minutes. In some embodiments the camera may have a water resistant rating of IPX8, meaning that it is waterproof in depths over 1 m, and preferably in depths up to 50 m. In other words, such a waterproof camera may withstand up to 5 atm of water pressure. Such a waterproof camera may be a still camera, but is preferably a video camera e.g. suited for live action filming.

A factor to be taken into account for a waterproof video camera, rather than a still camera, is that the camera preferably includes an audio receiver (e.g. a microphone) to record sound in addition to video image data. The camera body typically includes a physical opening to allow sound to reach the audio receiver. This is not an issue when the whole camera is housed in an external waterproof case, as is conventional. However, where the waterproof camera is to be used without an external waterproof case it preferably includes a removable cover for the audio receiver, so as to substantially prevent moisture from entering the camera body this way. A user may ensure that the cover is in place when the waterproof camera is being used in wet or dirty conditions. At other times it may be desirable to remove the cover to ensure that sound is not muffled. However, a cover for the audio receiver may be small, fiddly to handle and easy to lose. The Applicant has devised a particularly elegant solution for protecting the audio receiver, wherein the camera comprises a transparent lens cap arranged to substantially cover the audio receiver. Such a lens cap can therefore provide for dual protection in wet conditions by covering both the lens and the audio receiver.

Furthermore, the Applicant has appreciated that such a protective lens cap may be used to selectively protect not only the image sensing lens and audio sensing microphone, but any other sensors that may require an opening in the camera body that potentially interferes with the camera being fully waterproof. Preferably the transparent lens cap is arranged to substantially cover one or more other sensors, such as an audio transmitter, e.g. buzzer; and/or a pressure sensor, e.g. barometer.

According to a set of embodiments the transparent lens cover may make the camera at least splashproof by reducing the ingress of moisture but not completely closing off fluid communication between the external atmosphere and the audio receiver. Accordingly the transparent lens cap is preferably arranged to reduce fluid communication between the external atmosphere and the audio receiver (and optionally the one or more other sensors, where provided). This means that the audio receiver can still record sound while being protected from a wet/dirty environment. Such a lens cap may comprise a cylindrical body with an aperture arranged to align with the audio receiver when the cap is mounted in use. The cylindrical body can therefore substantially cover the lens with only the aperture allowing for minimal ingress of moisture. It will be appreciated that the aperture may be relatively small, e.g. of the order of 1-5 mm in size, so that splashes will not tend to penetrate the lens cap. Furthermore the aperture may be so small that for water pressures below 1 atm there is effectively no moisture penetration. Such a lens cap preferably has a water resistance rating of IPX7 (to withstand incidental exposure to water depths of up to 1 m for up to 30 minutes). As will be appreciated, the lens cap may comprise a plurality of apertures; one associated with the audio receiver, and another one or more associated with other sensors.

According to another set of embodiments the transparent lens cover may prevent the ingress of moisture by substantially closing off fluid communication between the external atmosphere and the audio receiver (and optionally the one or more other sensors, where provided). Such a lens cap may comprise a cylindrical body that surrounds and covers the lens when the cap is mounted in use. Such a lens cap preferably has a water resistance rating of IPX8 (to withstand immersion in water depths of up to 50 m, i.e. 5 atm).

This is considered novel and inventive in its own right, and thus according to a third aspect of the present invention there is provided a waterproof camera comprising a substantially sealed camera body, the camera body housing one or more sensors arranged in fluid communication with the external atmosphere, the camera further comprising a lens and a transparent lens cap arranged to cover the lens and substantially close off, or reduce, the fluid communication between the one or more sensors and the external atmosphere.

As discussed above, such a waterproof camera may be a still camera, but is preferably a video camera, e.g. suited for live action filming. Furthermore, the camera is preferably a digital image or digital video camera. By providing the transparent lens cap to protect the lens and sensor(s), the camera can be used outdoors without needing to encase the whole device in a separate waterproof case. Such embodiments can be particularly beneficial where the camera is a video camera, especially an action camera, which comprises more sensors than a conventional video camera to measure environmental conditions. Data from one or more such sensors may be recorded along with conventional video image and sound data to assist in editing the footage. In various embodiments the one or more sensors may comprise: an audio receiver, e.g. microphone; an audio transmitter, e.g. buzzer; and/or a barometric altimeter (or other atmospheric pressure sensor). The camera may further comprise one or more sensors that are housed inside the camera, for example: a gyroscope, e.g. a rate-gyro; an accelerometer, e.g. a 3D accelerometer; a global navigation satellite system (GNSS) receiver, such as a GPS receiver; and/or a compass.

The transparent lens cap is preferably removable, such that the user can swap, for example, between a lens cap with one or more apertures (e.g. a lens cap rated to IPX7) and a lens cap without any apertures (e.g. a lens cap rated to IPX8). A user can then select when to use the lens cap e.g. depending on ambient conditions. To help ensure that the camera is as waterproof as possible, especially when the lens cap is in position, a seal may be arranged between the camera body and the lens cap. For example, a compression seal such as a sealing ring (e.g. a rubber or elastomeric O-ring) may be located inside the lens cap and/or on the camera body around the lens. However the Applicant has found that a superior sealing performance may be provided by a lip seal or radial shaft seal. Accordingly, a lip seal is preferably arranged between the camera body and the transparent lens cap. The seal can be formed from a elastomeric material, e.g. rubber.

To assist in gripping and removing the transparent lens cap, the cap preferably comprises a cylindrical body having an outer surface that is textured, dimpled or knurled. Such surface texture may be formed in the cylindrical body itself, e.g. moulded into a plastic body or inscribed into a metal body. However it has been found advantageous to use a elastomeric, e.g. rubber, material to provide good grip. Thus according to a preferred set of embodiments the transparent lens cap further comprises an insert circumscribing an external surface of the cylindrical body. The insert is preferably formed from a elastomeric material, e.g. rubber.

The Applicant has also realised that in various embodiments the lens cap may advantageously be manufactured in an integral way. Preferably the transparent lens cap comprises a cylindrical body, and the seal is overmoulded onto an internal surface of the cylindrical body, such that the seal is integrally formed with the cylindrical body. Similarly, the insert is preferably overmoulded onto an external surface of the cylindrical body, such that the insert is integrally formed with the cylindrical body.

This is considered novel and inventive in its own right, and thus according to a fourth aspect of the present invention there is provided a lens cap for a camera, preferably a waterproof camera, comprising a transparent cover supported by a cylindrical body and a seal circumscribing an internal surface of the cylindrical body, the seal being overmoulded on the cylindrical body. The seal preferably comprises a compression seal or a lip seal, and is preferably formed of an elastomeric material, such as rubber. In embodiments, the lens cap further comprises an insert circumscribing an external surface of the cylindrical body, the insert being overmoulded on the cylindrical body, and wherein the insert is preferably formed from an elastomieric material, such as rubber. Most preferably, therefore, a rubber seal and a rubber insert are integrally formed and overmoulded on the cylindrical body.

In various embodiments of such a lens cap, the cylindrical body may comprise a bayonet mount for removably connecting the lens cap to a camera. Such a releasable mechanical connection is described in more detail below.

Returning to a waterproof camera comprising a transparent lens cap, in at least some embodiments the lens cap is removably connected to the camera body by a releasable mechanical connection. For an action camera using a transparent lens cap it is particularly important for the lens cap to be securely connected, as it protects the lens from ambient conditions during filming. This is unlike a standard camera lens cap that is only installed when the camera is not in use. The releasable mechanical connection is preferably one that provides a positive interconnect, for example one or more of a snap fit, screw connection or bayonet connection. In a set of examples the releasable mechanical connection comprises a bayonet connection. The camera body may include two or more bayonet mounting lugs and lens cap may include corresponding receivers, e.g. threads for the mounting lugs (or vice versa). The lens cap is installed by inserting the mounting lugs in the receivers, then rotating the lens cap and camera body relative to one another so that the mounting lugs travel along grooves extending circumferentially from the receivers. The grooves may be chamfered to help grip the mounting lugs. Accordingly the lens cap preferably comprises a bayonet mount for removably connecting the lens cap to the camera body. The bayonet mount may advantageously be moulded into the same cylindrical body, for example, that is integrally formed with the seal and/or insert as described above.

One or more different lens caps may be removably connected to the camera. For example, different lens caps may have different water resistance ratings. Thus in embodiments of the present invention there may be provided a kit comprising a waterproof camera as described herein, and a plurality of transparent lens caps, each lens cap being removable and having a different water resistance rating. The kit may include one or more lens caps having a water resistance rating chosen from one or more of: IPX7 (to withstand incidental exposure to water of up to 1 meter for up to 30 minutes); 1 atm (to withstand water pressures equivalent to a depth of 10 m); 2 atm (to withstand water pressures equivalent to a depth of 20 m); 3 atm (to withstand water pressures equivalent to a depth of 30 m); 4 atm (to withstand water pressures equivalent to a depth of 40 m); or 5 atm (to withstand water pressures equivalent to a depth of 50 m). A user may select, for example, the IPX7 lens cap for indoor/outdoor use in the presence of rain, snow or brief splashes of water and the 5 atm lens cap for sub-aqua activities involving complete immersion of the camera. One or more lens caps in such a kit may be designated as having a water resistance rating of IPX8, meaning that the lens cap is waterproof in depths over 1 m and up to 50 m.

In addition to the removable lens cap, the camera may comprise a removable power pack and sealing interface arranged between the camera and the power pack. As is discussed above in relation to the second aspect of the invention, such a removable power pack may be installed in or on the camera body. Preferably the removable power pack includes one or more electrical connectors for transmitting power to the camera once installed. The sealing interface prevents moisture from reaching the one or more electrical connectors.

There will now be described some features of a waterproof camera that are applicable to embodiments of the second or third aspects of the invention.

The one or more electrical connectors may be exposed on a surface of the removable power pack. The sealing interface may comprise a seal on a surface of the power pack and/or of the camera. The interface may be sealed when the surfaces are mated together by installing the power pack in or on the camera body. Of course one or more other surfaces of the power pack and/or camera may remain exposed after they have been sealingly connected together. The power pack is at least partially installed in or on the camera body to the extent that the sealing interface is established. In a preferred set of embodiments the sealing interface comprises a seal extending around a peripheral surface of the power pack. Optionally, the sealing interface may further comprise a seal extending around a peripheral surface of the camera body. In both cases the peripheral surface may be an inner surface or an outer surface.

In addition to the sealing interface, the waterproof camera may comprise a releasable mechanical connection between the camera body and the power pack. Such a mechanical connection may also provide a sealing function, but its primary function is to ensure that the power pack is securely installed in or on the camera body. For an action camera it can be particularly important that the power pack is securely connected and cannot work loose if the camera is subjected to varying forces and vibrations during filming, for example when mounted to a helmet or bicycle. The releasable mechanical connection is preferably one that provides a positive interconnect, for example one or more of a snap fit, screw connection or bayonet connection. In a set of examples the releasable mechanical connection comprises a bayonet connection. The power pack may include two or more bayonet mounting lugs and the camera body may include corresponding receivers for the mounting lugs. The mechanical connection is formed by inserting the mounting lugs in the receivers, then rotating the power pack and camera body relative to one another so that the mounting lugs travel along grooves extending circumferentially from the receivers. The grooves may be chamfered to help grip the mounting lugs. Preferably the mounting lugs are spaced at least 90 degrees apart for ease of connection. Two or three mounting lugs may be arranged around a periphery of the power pack.

A mechanical connection such as a bayonet connection may simply be released by manually reversing the steps used to form the connection, for example counter-rotating the power pack relative to the camera body so as to release the bayonet connection. However, the Applicant has realised there may be a risk of the mechanical connection being released accidentally when the camera is handled by a user (e.g. the camera body is connected to a mount) and/or due to movements during its use. This might be a particular risk for an action camera. It is therefore preferable for the camera to further comprise a lock for the releasable mechanical connection. The lock may be actuated automatically when the mechanical connection is made, for example a spring catch or the like. The lock may include a manual release, so that a user must release the lock before the mechanical connection can be released. This provides the mechanical connection with an extra level of security to avoid accidental removal of the power pack, which could otherwise interrupt action filming unexpectedly.

The releasable mechanical connection can be entirely separate to the sealing interface. However, it has been recognised that the releasable mechanical connection can advantageously be arranged so as to interact with the sealing interface and improve its sealing function. In such embodiments the mechanical connection may act on the sealing interface when the power pack is installed in or on the camera body. For example, a seal extending around a peripheral surface of the power pack and/or camera body may be compressed when the mechanical connection is made. This can help to ensure that the sealing interface is waterproof. A bayonet connection in combination with a peripheral sealing ring (e.g. O-ring) may provide a particularly convenient way for the mechanical connection to act on the sealing interface when the power pack and camera body are connected together.

As is mentioned above, the sealing interface may be formed between one or more peripheral surfaces of the power pack and camera body. For example, the power pack may locate over a part of the camera body so as to be substantially exposed after it has been installed, e.g. similar to an add-on accessory. However it is preferable for the power pack to be inserted at least partially into the camera body so that it is substantially protected by the camera body once installed. This can help to ensure that the power pack is shielded from knocks when the camera is used during sports activities. In a preferred set of embodiments the camera body comprises an open cavity arranged to receive the removable power pack therein. It is further preferable that the cavity has dimensions substantially matching the power pack such that, when the power pack is installed in the cavity, it forms part of a continuous surface of the camera body. Accordingly the power pack does not stand proud of the camera body, like a conventional add-on accessory, but integrates with the camera body. The resulting camera can be compact rather than bulky.

In any of the embodiments described above it can be convenient for the power pack to be substantially circular in cross-section, with a circular geometry for the sealing interface (e.g. one or more O-rings) and optionally for any releasable mechanical connection (e.g. a bayonet connection). The power pack may be substantially cylindrical in shape. In embodiments where the power pack is installed in an open cavity in the camera body, the cavity may also be substantially cylindrical. While the camera outside the cavity may have any shape or dimensions as desired, in some embodiments the camera body reflects the same cylindrical geometry. The camera body may take the form of a substantially cylindrical shell having an opening at one end for the cavity to receive a removable power pack. This can make it quick and easy for a user to install the power pack by sliding it axially into the cavity through the opening.

In various embodiments of the second or third aspects of the invention, the removable power pack comprises at least a battery module. This means that the camera does not need to have its own sealed battery compartment.

While the camera may comprise its own internal data storage module, for example a sealed module, this would require a data connection (wired or wireless) to be established when the memory is full and it is desired to record more data. As is discussed above, it can be particularly convenient when filming action sports to provide for replacement of data storage media as well as battery replacement. Accordingly the removable power pack preferably comprises a battery module and a data storage module. As is described above, in such embodiments the battery module and data storage module may be housed in a common casing to form an integrated unit. The casing may expose one or more electrical connectors (e.g. on a surface of the power pack) for transmitting power and data between the power pack and the camera.

The power pack may include one or more further features according to embodiments of any of the foregoing first to third aspects of the invention, which will now be discussed below.

The battery module may comprise one or more battery cells permanently installed therein, for example a rechargeable battery module. The power pack may include an auxiliary power input for the battery module.

As is already mentioned above, the data storage module may comprise a receiver for a removable data storage medium. The data storage medium may comprise a solid-state memory, preferably a non-volatile storage medium. For example, the data storage medium may be a flash memory or memory card, such as a Secure Digital (SD) format memory card.

In addition to the electrical connector(s) that transmit power and data between the power pack and the camera, it can be advantageous for the power pack to comprise one or more further connectors that enable power and/or data to be transmitted to/from an external device. For example, such further connectors may enable the battery module to be (re)charged before it is installed, or may enable data to be downloaded from the data storage module, without needing to use a camera connected to the power pack. In a preferred set of embodiments the power pack comprises a further connector on the form of an USB connector for transmitting power and/or data between the power pack and an external computing device (e.g. desktop computer, tablet, mobile phone, smart phone, etc.). A USB 3.0 connector may be preferred to ensure fast download speeds. The USB connector may also act as the aforementioned auxiliary power input for the battery module, or the power pack may have a separate auxiliary input.

Where the power pack comprises multiple electrical connectors for sharing data with different devices, it is desirable to be able to control the transfer of data. The power pack may therefore comprise a switch for determining whether data is transmitted to/from an external computing device via the USB connector or to/from a camera via the one or more electrical connectors. The power pack may include a user-operable switch for this purpose.

The Applicant has appreciated that a power pack comprising a data storage module can contribute to a user's control of the camera in new ways. In a preferred set of examples the power pack comprises at least one user input e.g. a button. The user input may simply control one or more functions of the power pack per se, for example switching on/off the electrical connector(s) to determine when power and data are transmitted between the power pack and the camera. However it is preferable that the user input controls one or more functions of the camera, for example controlling a start and/or stop for data recording. Such control commands may be transmitted by the electrical connector(s) to a microprocessor in the camera. Accordingly the electrical connector(s) may provide for two-way data communication in addition to power transmission.

In at least some embodiments the user input is arranged on a surface of the power pack so as to be exposed when the power pack is installed in or on the body of a camera. In those embodiments where the power pack is received in a cavity in the camera body, the user input may be arranged on an exposed surface of the power pack. This exposed surface may form part of a continuous surface of the camera body, so that the user input blends in with other controls provided by the camera. In those embodiments where the power pack is substantially cylindrical, as described above, the user input may be arranged on an end surface of the cylindrical power pack.

In various embodiments the power pack may comprise a visual indicator, for example one or more indicator lights (e.g. LEDs), to show the status of the battery module. For instance, a green light might indicate a charged battery module while a red light might indicate an empty battery module. In other examples, or in addition, the visual indicator may comprise a display screen, e.g. so that a graphical representation of the remaining power in the battery module can be displayed.

In various embodiments the camera may include a system-on-chip (SoC) processor for processing image or video data recorded by the camera. In various embodiments the camera includes a wireless transceiver, for example a short-range transceiver using infrared or radio frequency communication (e.g. Bluetooth protocol). This can enable the camera to wirelessly connect with one or more external sensors or devices, such as a heart rate monitor, cadence sensor, power meter, GPS-enabled watch, mobile telecommunications device, etc. Data from such external sensors or devices may be integrated with the image or video data recorded by the camera, and/or used to control the image or video data recorded by the camera.

The present invention in accordance with any of its aspects or embodiments may include any of the features described in reference to other aspects or embodiments of the invention to the extent it is not mutually inconsistent therewith. Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 shows a perspective view of a removable power pack for a camera;

FIG. 2 shows a perspective view of a camera body before a power pack is installed;

FIGS. 3A and 3B show examples of power packs being installed into a camera body;

FIGS. 4A to 4C show schematically how a memory card is inserted and a power pack is installed in or removed from the camera;

FIGS. 5A and 5B show front and back perspective views of a camera with a power pack installed;

FIGS. 6A and 6B show side perspective views of a camera with a removable lens cap;

FIGS. 7A and 7B show schematically how a transparent lens cap is removed and installed;

FIG. 8 shows a kit comprising a camera, removable power pack and two different transparent lens caps;

FIGS. 9A to 9D provide various views of a splashproof (IPX7) lens cap; and

FIGS. 10A to 10D provide various views of a waterproof (IPX8-5 ATM) lens cap.

### DETAILED DESCRIPTION OF THE PREFERRED EMBODIMENTS

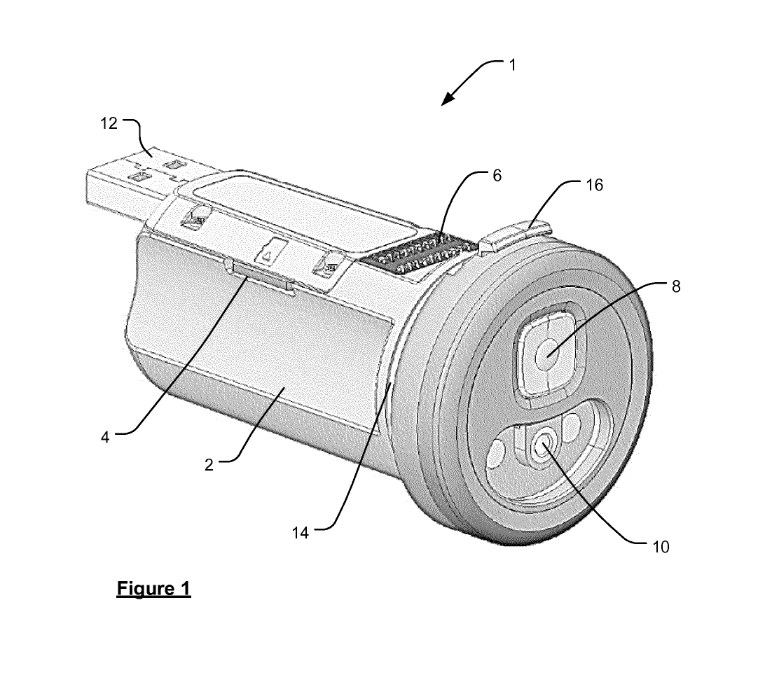

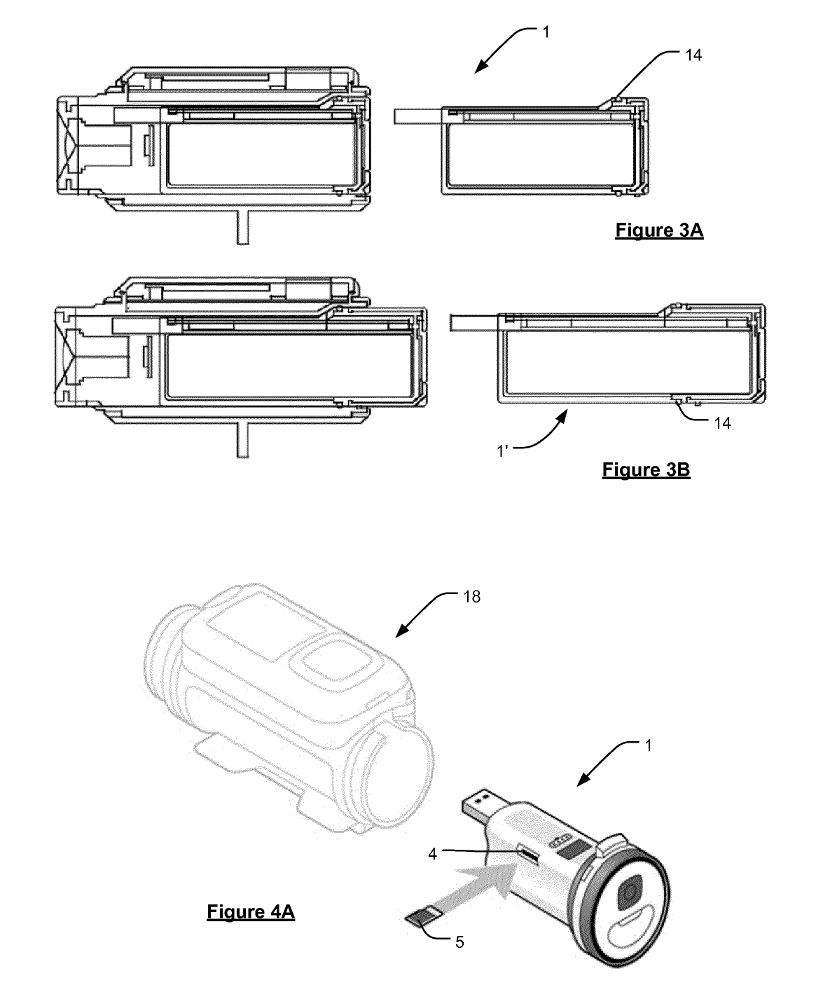

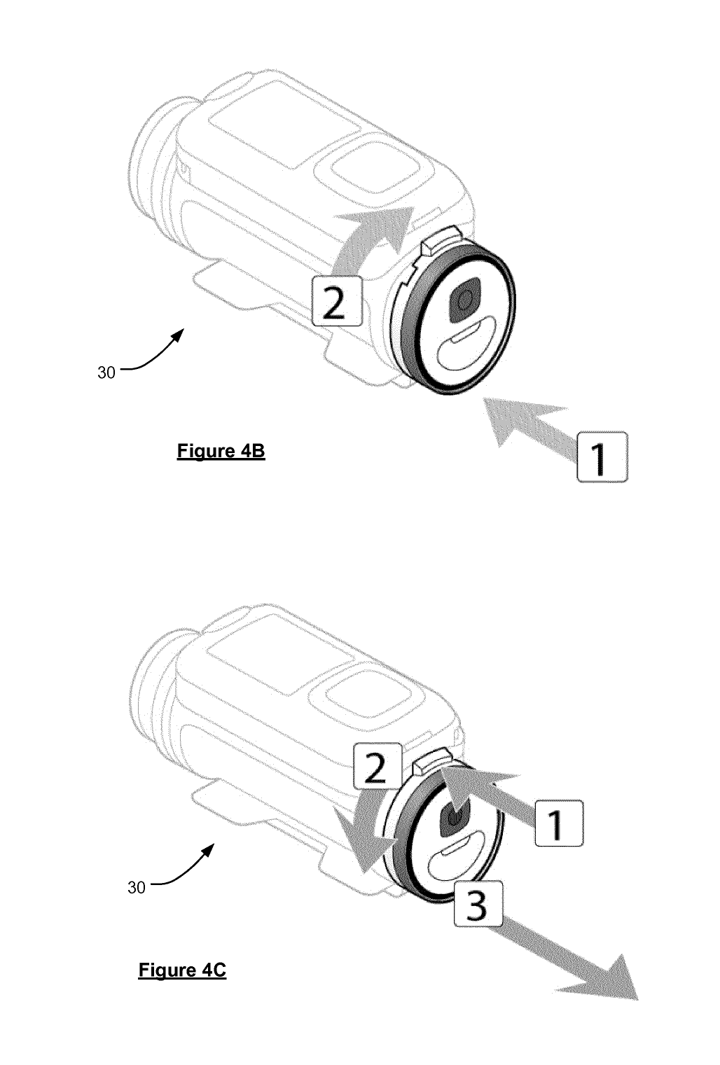

There is seen in FIG. 1 a removable power pack 1 for a camera, in particular for a waterproof camera. The power pack 1 takes the form of an integrated unit comprising a common casing 2 that houses an internal battery module and a data storage module. There is visible a slot 4 enabling a memory card to be inserted into the data storage module (see also FIG. 4A). An opening in the casing 2 exposes a set of electrical connectors 6 that enable power to be transmitted from the battery module in the power pack to a camera when coupled together. In addition, the electrical connectors 6 enable data to be transferred from the camera to the data storage module of the power pack 1 so that image and/or video data may be recorded on a memory card inserted in the slot 4. Furthermore, the electrical connectors 6 may also enable control command(s) to be transmitted from the power pack 1 to the camera. Such control command(s) may be input by the user control button 8 provided on an end surface of the casing 2. Even when the power pack 1 is inserted into a cavity in a camera body, the user control 8 is exposed for use.

Below the user control 8 there is seen an auxiliary input port 10 allowing an auxiliary power supply cable to be connected to the power pack 1 as desired. This may be used, for example, to recharge the battery module housed inside the casing 2. Although not shown, the input port 10 may be protected by a removable cover. Finally, it can be seen that the power pack 1 also comprises a USB connector 12, which may be used to link the power pack 1 to an external computing device such as a PC. The USB connector 12 may also be used to recharge the battery module, as well as enabling the download of data directly from the power pack 1 without needing to remove a memory card from the slot 4.

The power pack 1 includes various features enabling it to be removably installed into the body of a camera, in particular a waterproof camera. An O-ring seal 14 extends circumferentially around the power pack 1 so as to provide a sealing interface when the power pack 1 is inserted into a cavity in a camera. A manual release button 16 enables a mechanical connection between the power pack 1 and the camera to be unlocked when it is desired to remove the power pack 1.

FIG. 2 shows an exemplary camera body 18 that can receive the power pack 1 of FIG. 1 therein. It can be seen that the camera body 18 is substantially cylindrical comprising an internal cylindrical cavity 20 into which the power pack 1 can be inserted. The open end of the cavity 20 includes a pair of diametrically opposed chamfered threads 22 that can receive corresponding mounting lugs provided around the inwardly-facing periphery of the power pack 1. It will be understood that the power pack 1 may be mechanically connected by a bayonet connection formed by rotating mounting lugs on the power pack 1 along the chamfered threads 22 until the power pack 1 is locked in place. The camera body 18 includes a seat 24 for the manual release button 16.

Also seen in FIG. 2 is a user interface 26 mounted on a surface of the camera body 18 and a mounting system 28 comprising two mounting rings rotatably connected to the camera body 18. As shown, the user interface 26 may include one or more buttons and a display screen. The user interface 26 and mounting system 28 are described in more detail in the Applicant's co-pending application(s).

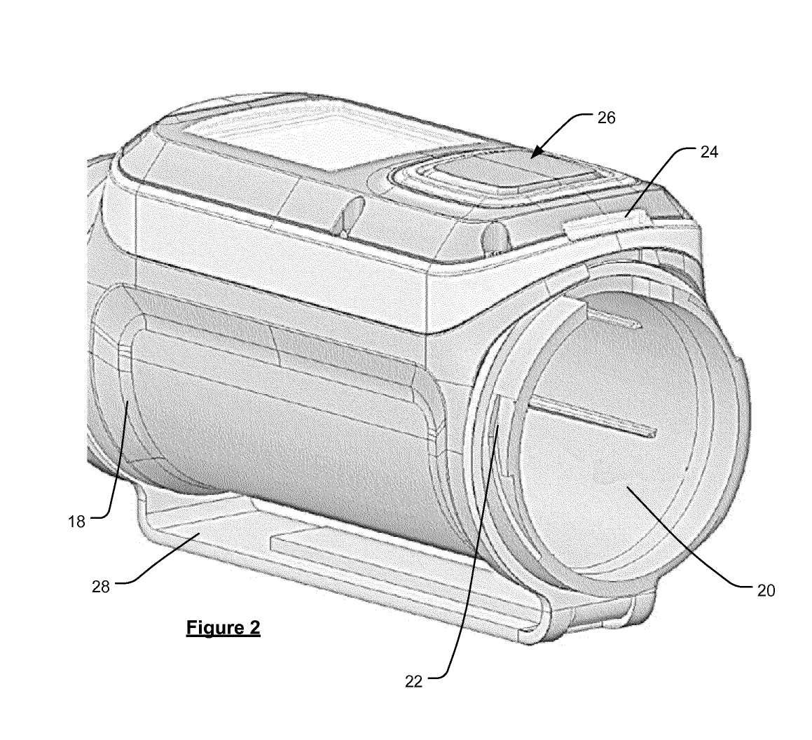

The cross-sectional views of FIGS. 3A and 3B show how different sizes of power pack 1, 1′ may be inserted into the cavity 20 of the same camera body 18. For example, the power pack 1 seen in FIG. 3A may provide a battery capacity of 2,000 mAh, while the power pack 1′ seen in FIG. 3B may provide a battery capacity of 3,000 mAh. It can be seen that both of the power packs 1, 1′ are substantially inserted into the cylindrical cavity of the camera body 18, the main difference being that the larger power pack 1′ protrudes out of the back of the camera body 18 rather than forming part of a continuous end surface of the camera body 18. However, it can be seen that in both cases the power pack 1, 1′ includes an O-ring seal 14 that ensures a sealing interface is formed between the camera body 18 and the inserted part of the power pack 1, 1′ that includes the exposed electrical connectors 6. This means that, once the power pack 1, 1′ is installed into the camera body 18, a waterproof seal may be created so that moisture cannot reach the data storage module, battery module and electrical connectors 6. The user control button 8 and auxiliary input 10 on the back of the power pack 1, 1′ may be rendered water resistant, so that the assembled camera is waterproof.

FIG. 4A shows how a memory card 5 can be inserted, with its contacts facing up, in the slot 4 of the power pack 1. FIG. 4B shows how the power pack 1 is inserted into the camera body 18 (step 1) and turned clockwise to lock the bayonet connection (step 2), with an audible “click”, to form a sealed camera 30. FIG. 4C shows how the power pack 1 may be removed from the camera 30 by pressing the manual release button 16 (step 1), then turning the power pack 1 anti-clockwise to undo the bayonet connection (step 2) and allow the power pack 1 to be pulled out (step 3).

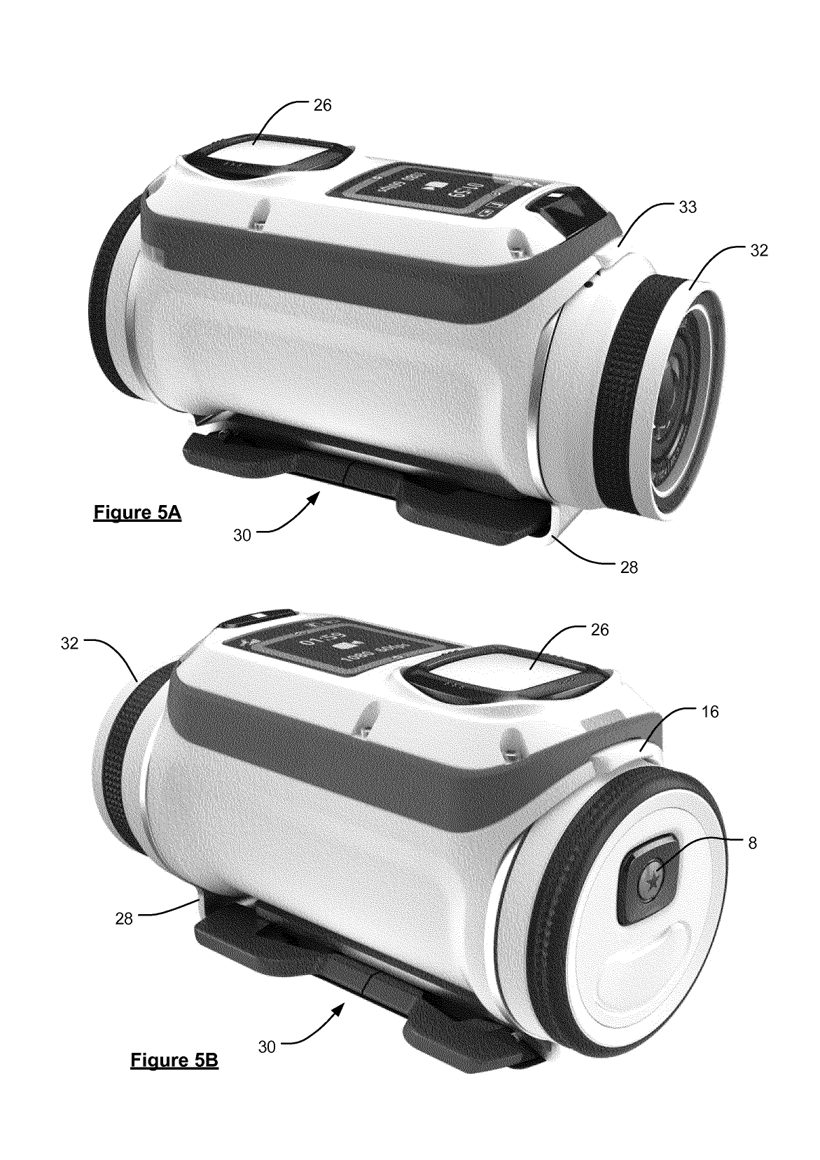

The perspective views seen in FIGS. 5A and 5B show the user interface 26 in more detail, as well as the compact shape of the camera 30 once the power pack 1 has been installed. It can be seen that the power pack 1 may be wholly inserted into the cavity in the camera body so that only its end surface carrying the user control button 8 is left exposed and forms part of a continuous surface of the camera body. Also visible in FIGS. 5A and 5B is a lens 32 on a font surface of the camera 30, positioned at an opposite end of the cylindrical body to the user control button 8. The camera body includes a manual release button 33 arranged next to the lens 32 for use with a removable lens cap, as is described further below.

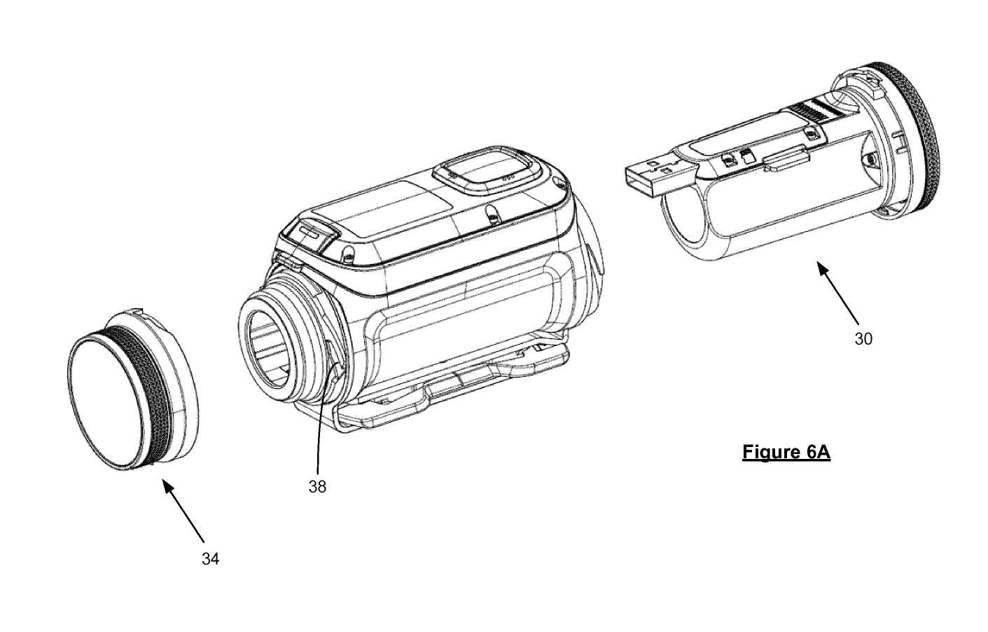

FIGS. 6A and 6B show how the lens 32 of the camera 30 is covered by a transparent lens cap 34, e.g. such that the camera 30 can be used in wet conditions. The transparent front surface of the lens cap 34 ensures that imaging is not detrimentally affected. The camera 30 includes an integrated microphone having a small opening next to the lens itself. With a conventional video camera, water is prevented from entering the camera through such a microphone opening by encasing the entire camera in a sealed, waterproof housing. In this embodiment the lens cap 34 seals over the lens 32 so as to close off the microphone opening or at least reduce the ingress of moisture. Optionally, a barometric altimeter (or other atmospheric pressure sensor) having another opening may also be associated with the lens 32 to sense the external air pressure. This sensor may also be protected by the lens cap 34 from substantially coming into contact with moisture. As is described in more detail below, the lens cap 34 includes a seal 36, such as a compression seal or lip seal, on its inner surface so as to ensure that a watertight seal is formed. The lens 32 includes a pair of bayonet mounting lugs 38 and the lens cap 34 includes a corresponding bayonet mounting thread 40 (or a reverse arrangement).

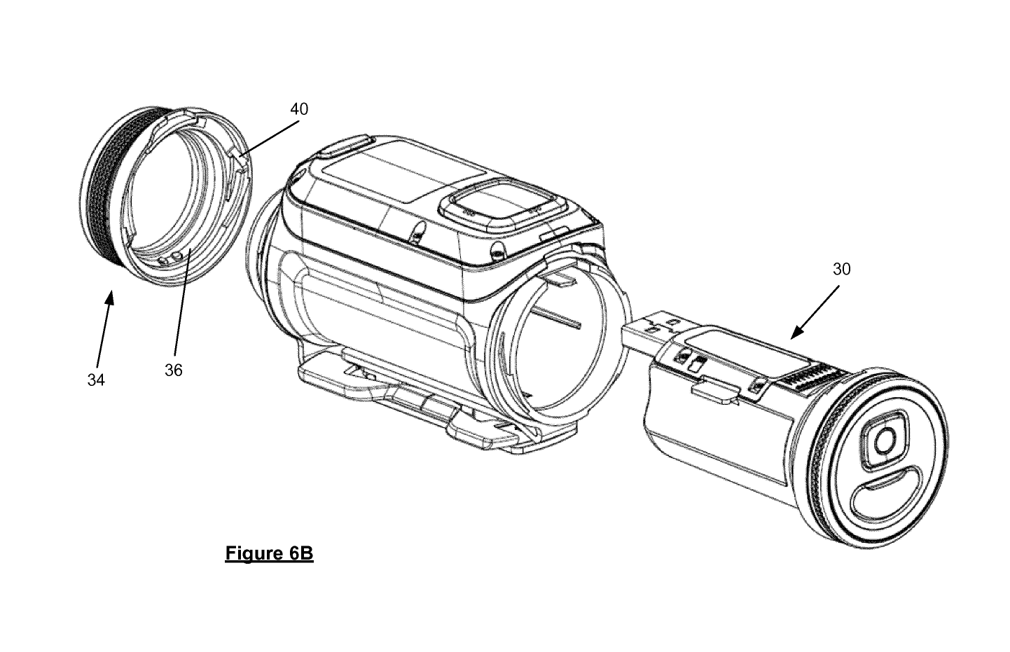

As is seen from FIG. 7A, a lens cap 34 can be removed from the front of the camera 30 by pressing the release button 33 (step 1), turning the lens cap 34 anticlockwise (step 2) and pulling the lens cap 34 away from the lens 32 (step 3). As is seen from FIG. 7B, a lens cap 34 can be installed by positioning the cap 34 over the lens 32 (step 1) and turning it clockwise until the bayonet connection is locked with an audible “click” (step 2). To prevent damage to the camera lens 32, it is recommended that the camera 30 is never used without a transparent cap 34.

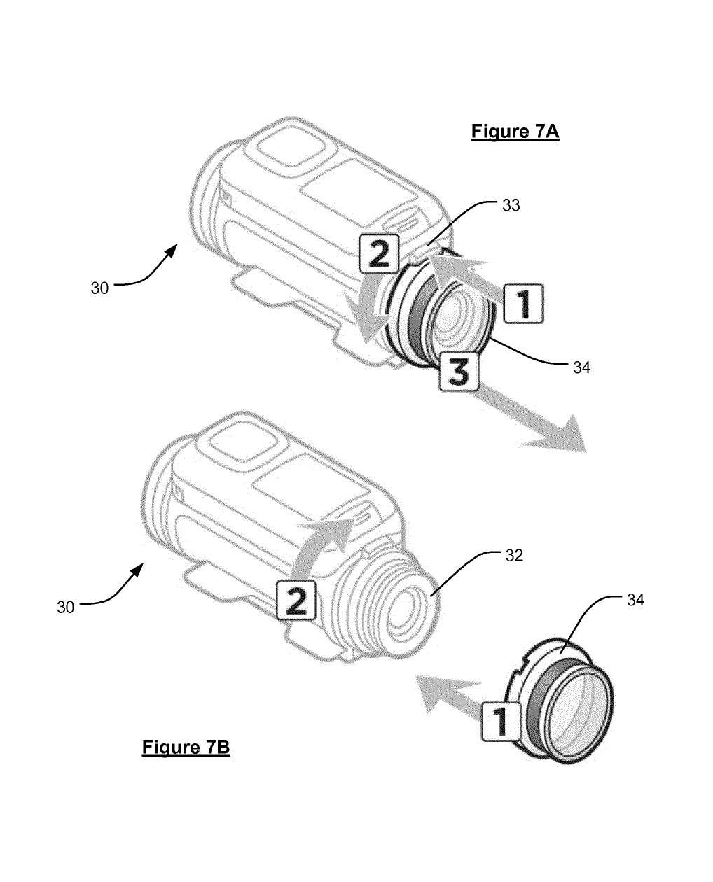

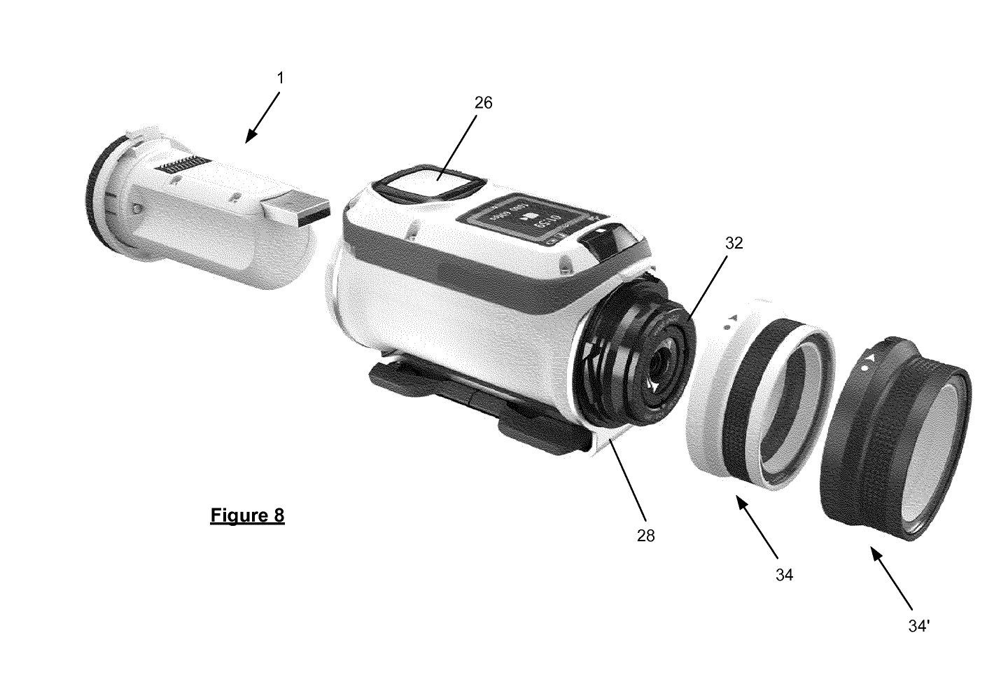

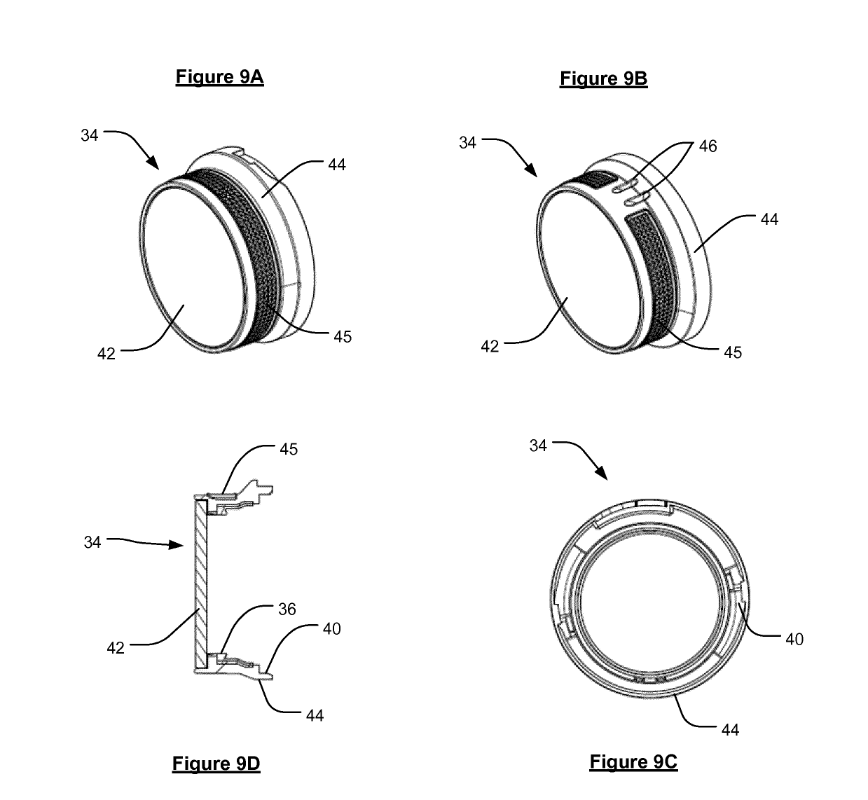

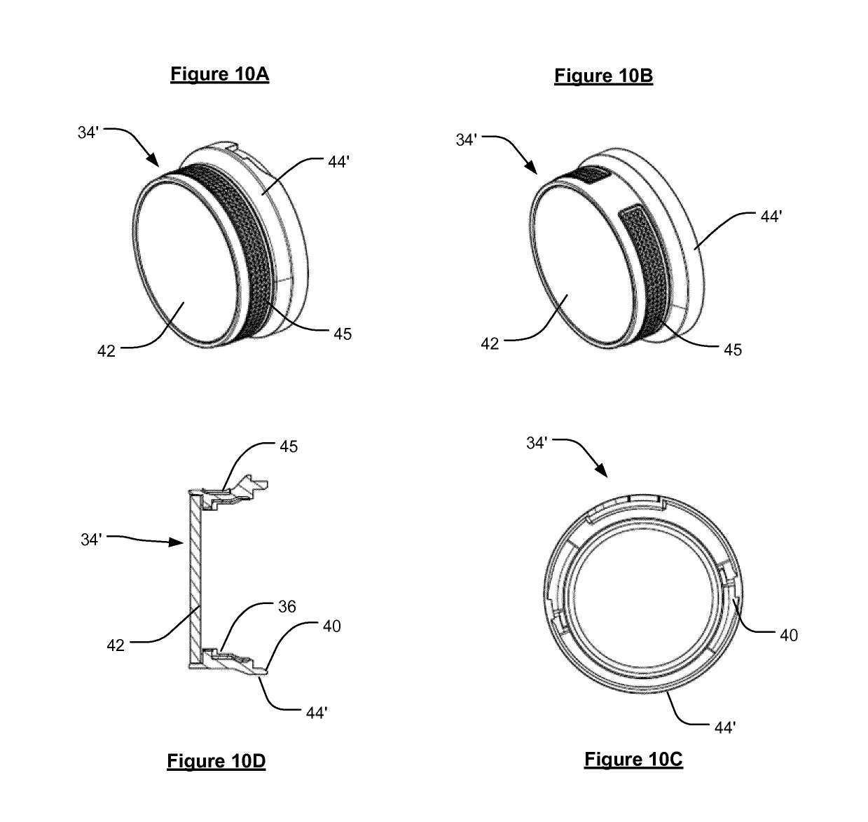

FIG. 8 shows a kit comprising a removable power pack 1, a camera body including a user interface 26 and a lens 32, and two different transparent lens caps 34, 34′. It may also be seen that the camera 30 includes a mounting system 28. The standard IPX7 lens cap 34 makes the camera 30 splashproof and waterproof up to 1 m for 30 minutes. In order to use the camera 30 underwater to depths down to 50 m, the lens cap 34 may be interchanged with an optional IPX8 (5 ATM) lens cap 34′. Optionally, any control buttons in the user interface 26 may be disabled when the camera 30 is used deep underwater. The two different lens caps 34, 34′ are seen in more detail in FIGS. 9 and 10.

FIGS. 9A and 9B are side perspective views of an IPX7 lens cap 34. The lens cap 34 comprises a transparent front cover 42 in the form of a disc and a cylindrical body 44 that supports the cover 42. The cylindrical outer surface of the cylindrical body 44 is at least partly covered by a textured or knurled insert 45 to assist a user in gripping and rotating the lens cap 34. The insert 45 may take the form of a rubber overmould. It is seen in FIG. 9B that the lens cap 34 includes two small apertures 46 in the cylindrical body 44. When the lens cap 34 is installed over a camera lens, these apertures 46 align with one or more sensors that require a fluid communication with the external atmosphere, for example a microphone to record audio data and/or a barometer to measure air pressure/altitude. The apertures 46 enable such sensors to function while helping to minimise the ingress of moisture, i.e. the lens cap 34 makes the camera at least splashproof if used on the surface and typically waterproof if used in depths up to 1 m for 30 minutes. The back view of FIG. 9C shows the bayonet mounting thread 40 on the inside of the cylindrical body 44. It can be seen from the sectional view of FIG. 9D that the knurled insert 45 takes the form of a rubber ring that is seated in an annular recess in the cylindrical body 44.

The side sectional view of FIG. 9D shows a lip seal 36 installed behind the transparent front cover 42. The lip seal 36 takes the form of a rubber overmould that is integrated formed with the cylindrical body 44. The lip seal 36, also known as a radial shaft seal, is not the same as an O-ring seal. The sprung sealing lip of a lip seal 36 has been found to provide a superior sealing performance. As is well known, such a lip seal 36 may comprise an elastomeric or thermoplastic sealing surface, typically spring-loaded by a garter spring, to seal dynamically against a countersurface surrounding the camera lens. Alternatively, the lip seal 36 may be replaced by an annular compression seal (such as a rubber O-ring or the like).

FIGS. 10A to 10D provide corresponding views of an IPX8 lens cap 34′. Such a lens cap 34′ can be installed to make a camera waterproof up to depths of 50 m (5 ATM). As before, the lens cap 34′ comprises a transparent front cover 42 and a cylindrical body 44′ that is at least partly surrounded by a textured or knurled insert 45 to assist a user in gripping and rotating the lens cap 34′. It is seen in FIG. 10B that the cylindrical body 44′ is uninterrupted and there are no apertures as in the IPX7 lens cap 34. When this lens cap 34′ is installed over a camera lens, any sensors such as microphone or barometer are completely closed off from fluid communication with the external atmosphere. It will be appreciated that a microphone is not generally used when filming underwater. The back view of FIG. 10C shows the same bayonet mounting thread 40 on the inside of the cylindrical body 44′ and the side sectional view of FIG. 10D shows the lip seal 36 behind the transparent front cover 42. The bayonet connection and lip seal are the same for both the IPX7 and IPX8 lens caps 34, 34′ so that they can be used interchangeably. The two different lens caps 34, 34′ may be moulded using the same tool, but with an insert provided in the moulding tool to make the cylindrical body 44′ without any apertures. This can reduce manufacturing costs.

1. A removable power pack for a camera comprising a battery module and a data storage module housed in a common casing to form an integrated unit, wherein the casing exposes: one or more electrical connectors for transmitting power and data between the power pack and the camera that receives the power pack; and one or more further electrical connectors for transmitting power and/or data between the power pack and an external computing device; wherein the removable power pack further comprises a seal extending around a peripheral surface of the casing so as to provide a sealing interface between the camera and the power pack.

2. The power pack of claim 1, wherein the one or more further connectors are arranged to receive power from the external computing device to charge the battery module.

3. The power pack of claim 1, wherein the one or more further connectors are arranged to transmit data from the data storage module to the external computing device.

4. The power pack of claim 1, further comprising a switch arranged to determine whether data is to be transmitted between: (i) the camera and the data storage module using the one or more electrical connectors; or (ii) the external computing device and the data storage module using the one or more further connectors, and to control the transfer of data based on the determination.

5. The power pack of claim 1, wherein the one or more further connectors comprise a USB connector.

6. The power pack of claim 1, further comprising an auxiliary power input that is connectable to an external power supply to charge the battery module.

7. The power pack of claim 1, wherein the data storage module comprises a receiver for a removable data storage medium.

8. The power pack of claim 7, further comprising a removable data storage medium, such as a memory card, installed in the data storage module of the power pack.

9. The power pack of claim 1, wherein the power pack is substantially cylindrical.

10. The power pack of claim 1, wherein the seal provides a sealing interface between the camera and the power pack, the sealing interface preventing moisture from reaching the one or more electrical connectors.

11. A removable power pack for a camera comprising a battery module in a casing, wherein the casing exposes one or more electrical connectors for transmitting power between the power pack and the camera that receives the power pack, and wherein the power pack comprises a seal extending around a peripheral surface of the casing, so as to provide a sealing interface between the camera and the power pack, when the power pack is installed in or on a camera body of the camera, to prevent moisture from reaching the one or more electrical connectors.

12. The power pack of claim 11, wherein the seal comprises one or more O-rings.

13. A camera comprising a camera body and the removable power pack of claim 10, installed in or on the body so as to provide a sealing interface between the camera and the power pack to prevent moisture from reaching the one or more electrical connectors.

14. The camera of claim 13, further comprising a releasable mechanical connection between the camera body and the power pack, optionally wherein the releasable mechanical connection comprises a bayonet connection.

15. The camera of claim 14, wherein the seal of the power pack is compressed when the mechanical connection is made between the camera body and the power pack, so as to provide the sealing interface.

16. The camera of claim 14, further comprising a lock for the releasable mechanical connection.

17. The camera of claim 16, wherein the lock includes a manual release that must be actuated by a user before the mechanical connection can be released.

18. The camera of claim 13, wherein the camera body comprises an open cavity arranged to receive the removable power pack therein.

19. The camera of claim 18, wherein the open cavity and the power pack are both substantially cylindrical.

20. The camera of claim 13, wherein the camera is waterproof to a depth of at least 5 m, 10 m, 20 m, 30 m, 40 m or 50 m.
